(19) United States
(12) Patent Application Publication
(10) Pub. No.: US 2014/0013710 A1
(43) Pub. Date: Jan. 16, 2014

(54) Pharmacy bagging leaflet

(71) Applicant: Rafik R. BEHMAN, Tarpon Springs, FL (US)

(72) Inventor: Rafik R. BEHMAN, Tarpon Springs, FL (US)

(21) Appl. No.: 13/987,571

(22) Filed: Aug. 8, 2013

Related U.S. Application Data
(63) Continuation of application No. 13/373,437, filed on Nov. 14, 2011.
Application No. 13/373,437 is a continuation of application No. 12/012,448, filed on Feb. 4, 2008, now abandoned.

(51) Int. Cl. A61J 1/03; B65D 33/00

(52) U.S. Cl. CPC A61J 1/03; B65D 33/004
USPC 53/411; 206/534; 493/243; 493/188

(57) ABSTRACT

The present invention relates to pharmacy operation apparatus intended for advancing prescription preparation procedures and more specific the process of bagging dispensed drug.

Pharmacy bagging leaflet comprises a rectangular paper sheet having upper and lower faces. The sheet has a fold line dividing the sheet into first and second sections, with the second section having wider margin than the first section, and the first section having a pocket structure, such that first and second sections when folded together will form a flat leaflet with a portion of the second section extending from the first section. Leaflet being loadable into a computer output printer, for receiving patient-drug information on the second section face, then leaflet being reversely folded with the first section overlying and covering second section printed face, such that drug private information being secured whereas patient information is visible and pocket opining being exposed.

### RELATED APPLICATIONS

This Application claims the priority of the Non-Provisional pending Application: Ser. No. 13/373,437 titled “privacy information securing bagging case” filed Nov. 14, 2011, and the abandoned Non-Provisional application No. 12/012,448, titled privacy information securing bagging case Filed Feb. 4, 2008, titled “Privacy Information Securing Bagging Case”

### BACKGROUND OF THE INVENTION

1. Field of the invention

The present invention features an apparatus intended for advancing prescription preparation procedure.

Pharmacy bagging leaflet relates to the field of pharmacy operation apparatus intended for bagging dispensed drug.

It is privacy information securing bagging case.

The present invention may be used for receiving and securing dispensed drug printed information and for bagging the same, whereas:

Printing dispensed drug information is one step, and

Bagging the dispensed drug is another.

Both printing and bagging steps involve paper work that can be combined.

This invention is intended to combine information printing and bagging of a dispensed drug.

2. Description of the Prior Art

In pharmacy business it is required by law that each dispensed drug must be bagged accompanied by its specific information.

Pharmacy must provide patients with drug information, such that,

For each dispensed drug a sheet including patient-drug information should be printed:

Patient name and Rx code for prescription identification, and

Drug information such as drug name, strength, indication, and side effects and alike for patient education.

The patient name and Rx code provide identification information for prescription pick up and should be visible, whereas the drug information being private information should be secured.

It is continues printing and bagging process for each dispensed drug, whereas:

I am a pharmacist and my job requires that I visually verify and match the dispensed drug with the picture of the prescribed drug on the computer screen and make sure they both the same.

After that I click accept, by clicking accept the printer would print a paper sheet that contains both patient information and drug information: The patient information part is to identify the right patient, and the drug information part is specific for each drug and is private information.

First I have to tear off the patient information part from the drug information part.

Second I have to fold the drug information part and make it fit inside a bag.

Third I have to insert the folded drug information part with the dispensed drug into the bag.

Forth I have to staple the patient information part to the bag for patient identification purposes and make sure that the bag is stapled and sealed.

This process takes a lot of pharmacist time and effort, and is also subject to mistakes.

Recently pharmacies use separate paper sheet and separate bag, the sheet being used for receiving dispensed drug printed information, and the bag for bagging the dispensed drug.

In the field of pharmacy operation innovations for advancing prescription preparation procedures and more specific the process of bagging dispensed drug, the present invention, the bagging leaflet is the first of its kind as of any combined leaflet pocket apparatus.

In the field of pharmacy operation innovations there is no history of using pocket attached leaflet or alike for receiving and securing dispensed drug printed information and bagging the same.

Pharmacy bagging leaflet is an invention that combines both receiving and securing dispensed drug printed information and bagging the same.

### SUMMARY OF THE INVENTION

IN ONE EMBODIMENT THIS INVENTION PROVIDES A PHARMACY BAGGING LEAFLET COMPRISING:

A folder comprising at least two foldable sections.

One of the folder sections is partially or totally designed as a pocket, this sheet is double walled with at least one open side designed as a pocket.

One of the folder's faces left blank for printing purposes while in use.

The other face may be preprinted with an advertisement or privacy agreement or any other issue during manufacture.

So that when in use folders are used in place of the printer papers, placed one on top of the other.

Pharmacist would match the dispensed drug with the picture of the prescribed drug and clicks accept, the printer would print the patient information and the drug information on the blank face of the folder sections.

The pharmacist would then insert the dispensed drug into the bag designed section of the folder and would fold the folder sections with each other with the printed faces facing each other from inside so that the information of the drug is hidden and private.

One of the folder sections having wider margin so that some of the folded printed section's information becomes visible.

The pharmacist would then seal or staple the bag designed section with other sections of the folder.

It is an object of the present invention to provide the pharmacy bagging leaflet to combine both receiving information printing and bagging of a dispensed drug in one single step, to avoid the unnecessary steps of tearing, folding, inserting and stapling.

It is another object of the present invention to provide the pharmacy bagging leaflet to avoid tearing printed paper sheet to separate different information parts.

It is further object of the present invention to provide the pharmacy bagging leaflet to avoid folding printed paper to fit inside a bag.

It is yet another object of the present invention to provide the pharmacy bagging leaflet to avoid inserting the folded part of the printed paper into a bag.

It is a further object of the present invention to provide the pharmacy bagging leaflet to avoid stapling a patient information tag to a bag.

It is further objective of the present invention to provide the pharmacy bagging leaflet to avoid mistakes involved in the two separate steps, printing specific dispensed drug information and bagging the same, such as switching the two different patient information tags.

### BRIEF DESCRIPTION OF THE DRAWINGS

A fuller understanding of the present invention may be obtained by reference to the accompanying drawings, when taken in conjunction with the detailed description thereof and in which:

FIGS. 1 and 2 are plan views of a single first section and varying numbers of second sections of the bagging leaflet.

FIGS. 3 and 4 are front prospective views of a single first section and varying numbers of second sections of the bagging leaflet.

FIG. 5 is a perspective illustration of one sheet of the bagging leaflet prior to fabrication.

FIG. 6 is a perspective illustration of the bagging leaflet with the pocket structure.

FIG. 7 is a perspective illustration similar to FIG. 6 but after being folded.

FIG. 8 is a perspective illustration of the bagging leaflet after receiving patient drug information and after being reversely folded with the pocket exposed ready for receiving dispensed drug.

FIG. 9 is illustration steps for providing pharmacy bagging leaflet.

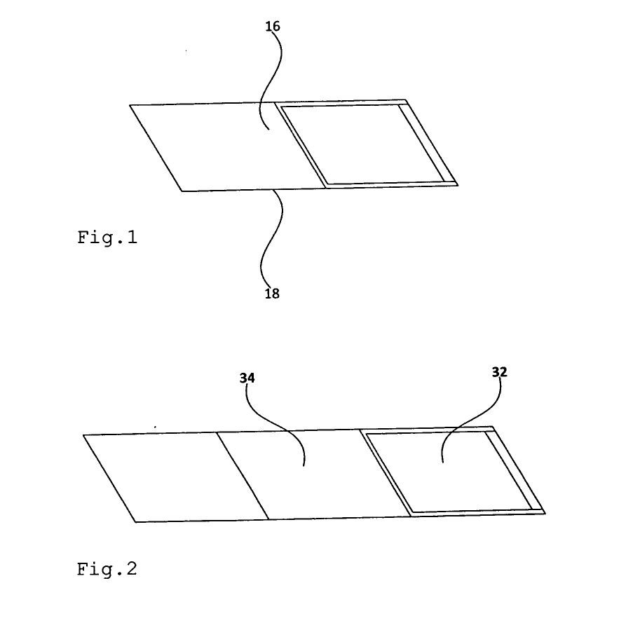

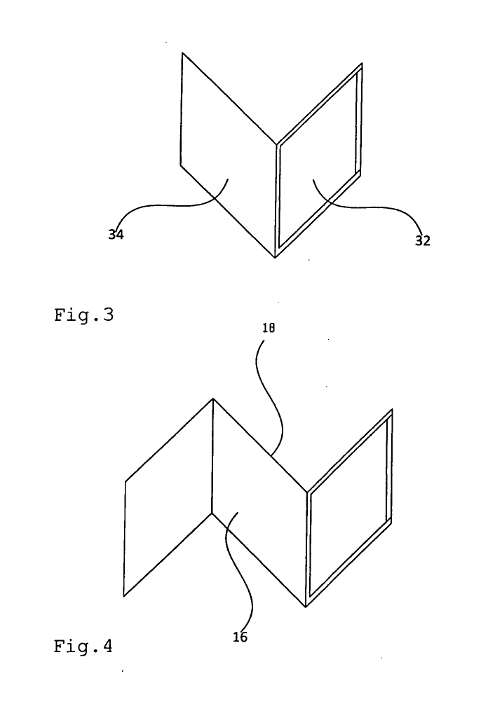

### DETAILED DESCRIPTION OF THE PREFERRED EMBODIMENTS

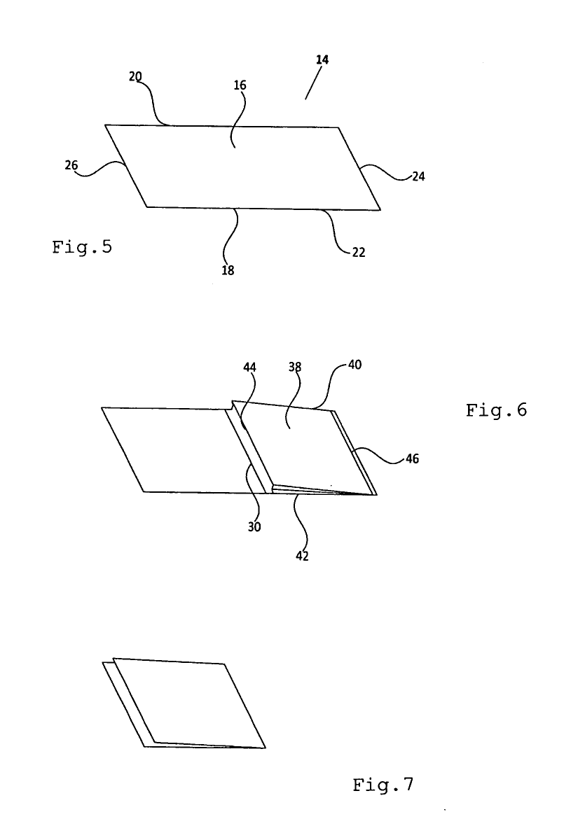

Referring now to the drawings in FIGS. 5, 6, 7 and 8

First provided in the bagging leaflet (10) of the present invention is a sheet (14) of printable paper, the sheet having an upper face (16) and a lower face (18), the sheet having a horizontal upper edge (20) and a parallel lower edge (22) separated by a height, the sheet having a vertical first side edge (24) and a parallel second side edge (26) separated by a length.

Next provided is a vertically spaced fold line (30) located between and parallel with the first and second side edges, the vertical fold line dividing the sheet into a first section (32) and a second section (34), each of the sections being in a rectangular configuration with the second section (34) having wider margins than first section (32).

Next, a folder sheet (38) is provided. The folder sheet overlies the upper face of the first section of the sheet. The folder sheet being rectangular, and of a size slightly less than the size of the first section. The folder sheet has an upper horizontal peripheral edge (40) and a lower horizontal peripheral edge (42). The folder sheet has an interior vertical peripheral edge (44) and an exterior vertical peripheral edge (46). The upper and lower horizontal peripheral edges and the exterior vertical peripheral edge being coupled to the first section with the folder sheet and the first section of the sheet forming a pocket with an opening at the interior vertical edge of the folder sheet for the receipt and bagging of a dispensed drug.

Next, the upper face of the sheet comprises different business issues printed during manufacture of the leaflet (54).

Referring to FIGS. 5, 6 and 7, the sheet (14) being flat with the first section (32) peripherally coupled with a folder sheet (38) to form a flat pocket, and the second section (34) having wider margin than the first section (32) such that the sheet when folded along the fold line (30) with the first section overlying the second section upper face will form a flat leaflet with a portion of the second section extending from the vertical edge (24) of the first section;

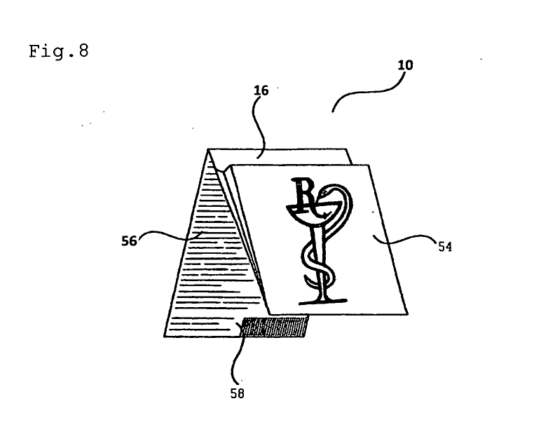

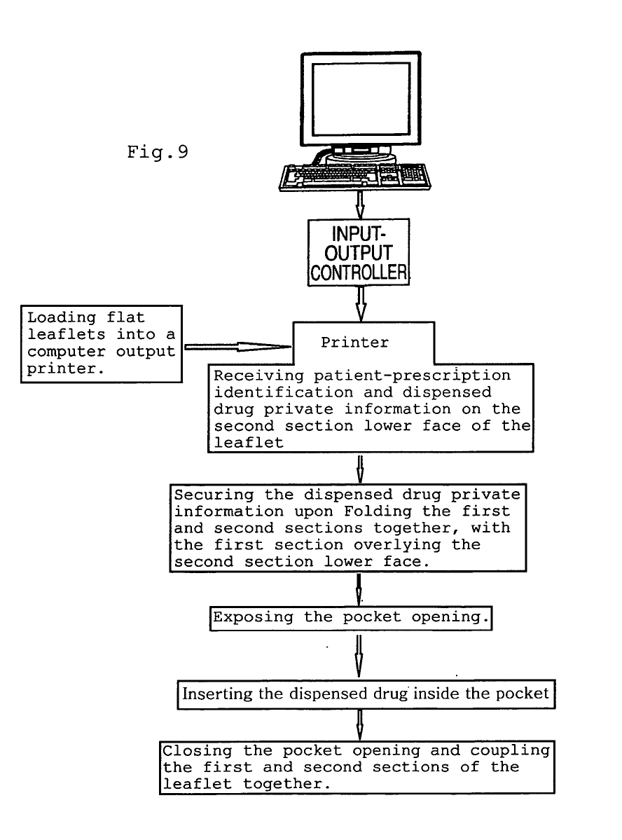

Referring to FIG. 7, the leaflet being flat for facile feeding into a computer output printer for receiving printed means on the second section lower face;

Referring to FIG. 8, the printed means including two fields of computer output information, a first field of a dispensed drug private information involving the main part of the second section lower face (56), and a second field of patient-prescription identification information involving the extended part of the second section lower face (58);

Referring to FIG. 8, the leaflet provides means for securing the dispensed drug private information upon reversely folding the first and second sections along the fold line (30) with the first section (32) overlying the second section (34) lower face, such that the main part (56) being covered, whereas the extended part of the second section lower face (58) being visible and the pocket opening being exposed.

Next provided is a dispensed drug movable through the pocket opening into a location inside the pocket

Lastly a staple closes the pocket opening and couples the first and second sections together

What is claimed is:

1. Pharmacy bagging leaflet comprising:
a printable sheet having upper and lower faces, the sheet having horizontal upper and lower edges separated by a height, the sheet having a vertical first and second side edges separated by a length; and
a vertically spaced fold line located between and parallel with side edges, the vertical fold line dividing the sheet into a first section and a second section, each of the sections being in a rectangular configuration with the second section having wider margins than the first section; and
said first section of the sheet having a pocket structure for receipt and bagging of a dispensed drug; and
said upper face of the sheet comprising different business issues printed during manufacture of the leaflet.

2. The bagging leaflet of claim 1, wherein said first and second sections of the sheet when folded together, with first section overlying second section upper face, will form a flat leaflet with a portion of the second section extending from first section vertical edge.

3. The bagging leaflet of claim 2, wherein said leaflet being flat for facile feeding into a computer output printer for receiving printed means on second section lower face.

4. The bagging leaflet of claim 3, wherein said printed means includes two fields of computer output information, a first field of dispensed drug private information involving main part of second section lower face, and a second field of patient-prescription identification information involving extended part of second section lower face.

5. The bagging leaflet of claim 4, wherein leaflet provides means for securing dispensed drug private information, said when reversely folding the first section to overly second section lower face, such that main part of second section lower face being covered, whereas extended part of second section lower face being visible and the pocket opening being exposed.

6. Pharmacy bagging leaflet comprising:
a paper sheet having upper and lower faces, the sheet having horizontal upper and lower edges separated by a height, the sheet having a vertical first and second side edges separated by a length; and
a vertically spaced fold line located between and parallel with side edges, the fold line dividing the sheet into a first section and a second section, each of the sections being in a rectangular configuration with the second section having wider margin than the first section; and
a folder sheet overlies the upper face of the first section of the sheet, the folder sheet being rectangular, and of a size slightly less than the first section, the folder sheet being peripherally coupled to the first section of the sheet to define a pocket with an opening towards the fold line of the sheet for receipt and bagging of a dispensed drug; and
said upper face of the sheet comprises different business issues printed during manufacture of the leaflet; and
said first and second sections of the sheet when folded together, with the first section overlying second section upper face, will form a flat leaflet, with a portion of the second section extending from first section vertical edge; and
said leaflet being flat for facile feeding into computer-output printer for receiving printed information on second section lower face; and
said printed means includes two fields of computer output information, a first field of a dispensed drug private information involving main part of second section lower face, and a second field of patient-prescription identification information involving extended part of second section lower face; and
said leaflet provides means for securing dispensed drug private information, said when reversely folding the first section to overly second section lower face, such that main part of second section lower face being covered, whereas extended part of second section lower face being visible and the pocket opening being exposed.

7. A method for providing pharmacy bagging leaflet comprising the steps of:
providing a rectangular paper sheet having upper and lower faces; and
forming a fold line that divides the sheet into first and second sections with the second section having wider margin than the first section; and
forming a pocket on first section upper face; and
folding the first and second sections together, with the first section overlying second section upper face to form a flat leaflet, with the second section extending from first section.

8. The method of claim 7, wherein step of loading leaflets into a computer output printer.

9. The method of claim 8, wherein step of receiving computer output printed information on second section lower face of the leaflet.

10. The method of claim 9, wherein said printed information includes two fields of computer output information, a first field of a dispensed drug private information involving main part of second section lower face, and a second field of patient-prescription identification information involving extended part of second section lower face.

11. The method of claim 10, wherein step of securing the dispensed drug private information by reversely folding the first section to overly second section lower face, such that main part of second section lower face being covered, whereas extended part of second section lower face being visible and the pocket opening being exposed.

12. The method of claim 11, wherein step of inserting a dispensed drug into the pocket through the pocket opening.

13. The method of claim 12, wherein step of closing the pocket opening and coupling the first and second sections together.
